(19) United States
(12) Patent Application Publication
(10) Pub. No.: US 2023/0410127 A1
(43) Pub. Date: Dec. 21, 2023

(54) Blockchain-based Carbon Emission/Energy Consumption Data Management and Operation System and Method of Enterprises

(71) Applicants: SCIENCE AND TECHNOLOGY BRANCH OF TAIZHOU HONGCHUANG ELECTRIC POWER GROUP CO., LTD, Taizhou (CN); STATE GRID TAIZHOU POWER SUPPLY COMPANY, Taizhou (CN)

(72) Inventors: Hongliang Zou, Taizhou (CN); Xueyan Wang, Taizhou (CN); Xiaocao Zuo, Taizhou (CN); Ye Ye, Taizhou (CN); Dengdiao Li, Taizhou (CN); Yongliang Jiang, Taizhou (CN); Yanxiang Fang, Taizhou (CN)

(21) Appl. No.: 18/242,579

(22) Filed: Sep. 6, 2023

Related U.S. Application Data
(63) Continuation of application No. PCT/CN2022/138374, filed on Dec. 12, 2022.

(30) Foreign Application Priority Data
Jun. 7, 2022 (CN) 202210632326.0

(51) Int. Cl. G06Q 30/018

(52) U.S. Cl. CPC G06Q 30/018

(57) ABSTRACT

The present invention discloses a blockchain-based data management and operation system and method for carbon emission/energy consumption of enterprises, and the method comprises the following steps: S1, the enterprise port collects operation data; S2, the data center control calculates regional production indicators and regional prediction data based on the operation data; S3, the data center control determines whether the regional prediction data exceeds the regional target data, and if so, obtains the regional energy consumption reduction task and the regional carbon emission reduction task according to the regional production data and the regional prediction data; S4, the data center control distributes enterprise-level assessment indicators to the enterprise according to the enterprise-level production indicators and the regional production indicators; S5: the enterprise port and the regional data display port visually display the data respectively.

### CROSS REFERENCE TO RELATED APPLICATIONS

The present application is a Continuation Application of PCT Application No. PCT/CN2022/138374 filed on Dec. 12, 2022, which claims the benefit of Chinese Patent Application No. 202210632326.0 filed on Jun. 7, 2022. All the above are hereby incorporated by reference in their entirety.

### TECHNICAL FIELD

The invention involves the data processing technology, in particular to a blockchain-based enterprise carbon emission/energy consumption data management and operation system and method.

### BACKGROUND OF THE INVENTION

With the development of economy, environmental pollution and energy consumption issues have become more and more prominent. Carbon emission is a vital type of environmental pollution that will lead to environmental problems such as greenhouse effect.

Therefore, it is urgent to build a data platform that connects all sides and can realize information data interaction, information data analysis, information data sharing and integrated information data analysis.

### SUMMARY OF THE INVENTION

In order to overcome the shortcomings and problems in the prior art, the present invention provides an enterprise carbon emission/energy consumption data management and operation method based on blockchain.

In order to achieve the above purpose, the present invention adopts the following technical scheme:

A blockchain-based enterprise carbon emission/energy consumption data management and operation method, comprising:
S1, the enterprise port collects and sends operation data to the data center control, wherein the operation data include water consumption data, electricity consumption data, coal consumption data, gas consumption data, heat consumption data, output value data and equipment data of the enterprise;
S2, the data center control substitutes the operation data into the intelligent production accounting model to obtain enterprise-level production indicators, accumulates all the enterprise-level production indicators in the region to obtain regional production indicators, and substitutes the regional production indicators into the prediction algorithm to obtain regional prediction data, wherein the production indicators comprise carbon emission indicators, energy consumption indicators and economic indicators; and region refers to a collection of all enterprise ports within a certain geographical range;
S3, the data center control is pre-set with regional target data, and determines whether the regional prediction data exceeds the target data, and if so, obtains the regional energy consumption reduction task and the regional carbon emission reduction task according to the difference between the regional production data and the regional prediction data;
S4, the data center control calculates the enterprise-level energy consumption reduction potential value and the enterprise-level carbon emission reduction potential value according to the enterprise-level production indicators and the regional production indicators, allocates the regional energy consumption reduction task and the regional carbon emission reduction task based on the two potential values to obtain the enterprise-level assessment indicators, and sends the enterprise-level assessment indicators to the corresponding enterprise port, and the regional production indicators, regional prediction data, regional energy consumption reduction tasks, regional carbon emission reduction tasks and enterprise-level assessment indicators to the regional data display port;
S5, the enterprise port visually displays the enterprise-level operation data and the enterprise-level assessment indicators, and the regional data display port visually displays regional production indicators, regional prediction data, regional energy reduction tasks, regional carbon reduction tasks and enterprise-level assessment indicators.

Preferably, S2 specifically comprises the following steps:
S21, compiling the production calculation formula into a production calculation formula in the form of intelligent contract code, wherein the production calculation formula comprises a carbon emission calculation formula, an energy consumption calculation formula and an economic calculation formula;
S22, compiling the production calculation formula in the form of intelligent contract code into the intelligent contract to obtain an intelligent production accounting model, which contains a signature, a timestamp and a Hash function;
S23: substituting the operation data into the intelligent production accounting model to calculate the enterprise-level production indicators, which will be uploaded to the blockchain network; the blockchain network comprises blockchain nodes, and the blockchain nodes comprise enterprise ports, data center control and regional data display port.

Preferably, the intelligent contract code adopts Turing complete programming language.

Preferably, the carbon emission calculation formula is

Eₜₒₜₐₗ=Σᵢⁿ(NCVᵢ×FCᵢ×CCᵢ×OFᵢ×44/12)+(ΣETDₘ+E_{WD})+(AD_{electricity}×EF_{electricity})+(ADₕₑₐₜ×0.11)

In which, Eₜₒₜₐₗ refers to the total greenhouse gas emissions of an enterprise, i refers to the types of fossil fuels, NCV refers to the average low calorific value of the type i fossil fuels, FCᵢ refers to the net consumption of the type i fossil fuels, CCᵢ refers to the unit heat value carbon content of the type i fossil fuels, OFᵢ refers to the carbon oxidation rate of the type i fossil fuels, m refers to the types of greenhouse gases, ETDₘ refers to the leakage of the type i greenhouse gas, AD_{electricity} refers to the net purchased electricity of the enterprise, EF_{electricity} refers to the annual average emission factor of the power grid in the region, and ADₕₑₐₜ refers to the net purchased heat of the enterprise;

Preferably, S3 specifically comprises the following steps:
S31, the regional data display port visually displays a slidable time progress bar;
S32, when the time progress bar is slid on the regional data display port, the regional data display port can display regional production indicators and regional prediction data of different time.

Preferably, when determining whether the regional prediction data exceeds the regional target data, it specifically comprises the following steps:

The data center control determines whether the regional prediction data at a certain time node exceeds the regional prediction value at the corresponding time node.

Preferably, it further comprises:
S6, the data center control determines whether the enterprise production indicators have the corresponding enterprise assessment indicators, if so, whether the former are higher than the latter, and if so, it determines that the enterprise has won the policy reward;

Preferably, it further comprises:
S7, the data center control is set with a new energy equipment database, from which the new energy equipment data are retrieved based on the operation data and production indicators. The new energy equipment database is a collection of new energy equipment data, including the model, quantity and price of new energy equipment;
S8, an energy saving and emission reduction report is generated based on the operation data, production indicators and new energy equipment data, and sent to the enterprise ports. In the report, new energy equipment data, input amount, configuration capacity, configuration scale of new energy equipment, annual energy saving value after new energy equipment input, annual carbon reduction value after new energy equipment input, energy consumption ratio before and after new energy equipment input, carbon emission ratio before and after new energy equipment input, return ratio of new energy equipment input, prediction annual return rate after new energy equipment input, and return cycle after new energy equipment input are included;
S9, enterprise port visually displays the energy saving and emission reduction report;

Preferably, the new energy equipment database is provided to the data center control through the supplier port. Compared with the prior art, the present invention has the outstanding and beneficial technical effects that:

(1) In the present invention, the enterprise display port comprehensively collects all the data generated during operation of the enterprise, and calculates by the intelligent production accounting model to obtain enterprise-level production indicators, thus avoiding the tedious manual calculation, realizing the continuous processing of data automation, improving the efficiency of data management and operation, and ensuring the quality of data.

(2) In the present invention, the enterprise display port, the data center control and the regional data display port update the data in real time to provide users the latest and most reliable carbon emission and energy consumption data.

(3) In the present invention, the enterprise port, the data center control and regional data display port constitute the blockchain network, to which enterprise production indicators and such data are uploaded, and may be viewed at all nodes of the blockchain network, thus avoiding data tampering or loss. Therefore, the blockchain-based enterprise carbon emission/energy consumption data management and operation method has the advantages of high data reliability, high authenticity, full traceability, and transparency.

(4) In the present invention, the intelligent production accounting model is constructed by intelligent contract, which makes the data accounting in a closed execution state. This is a highly trusted environment that allows accounting without a third party. The intelligent production accounting model is coded, and the whole accounting process is automatic and efficient, which saves human intervention, reduces measuring and accounting errors and improves data accuracy.

(5) In the present invention, the government side, the power grid side, the new energy enterprise side and the industrial enterprise side can interact and communicate data through the nodes of the blockchain network, thus solving the problem of breakpoints in data interaction on each side, and achieving the effect of data interconnection, in which data browsing, supervision, acquisition and transmission are easier and more convenient, all sides are complementary to each other, and the work efficiency is improved.

### BRIEF DESCRIPTION OF THE DRAWINGS

FIG. 1 is the schematic diagram of the step process of the present invention;

FIG. 2 is the schematic diagram of the frame structure of the system of the present invention;

1—Data center control; 2—Enterprise port; 3—Regional data display port; 4—Supplier port.

### DETAILED DESCRIPTION OF THE PREFERRED EMBODIMENT

In order to facilitate the understanding of those skilled in the art, the present invention will be further described with reference to the attached drawings and specific embodiments.

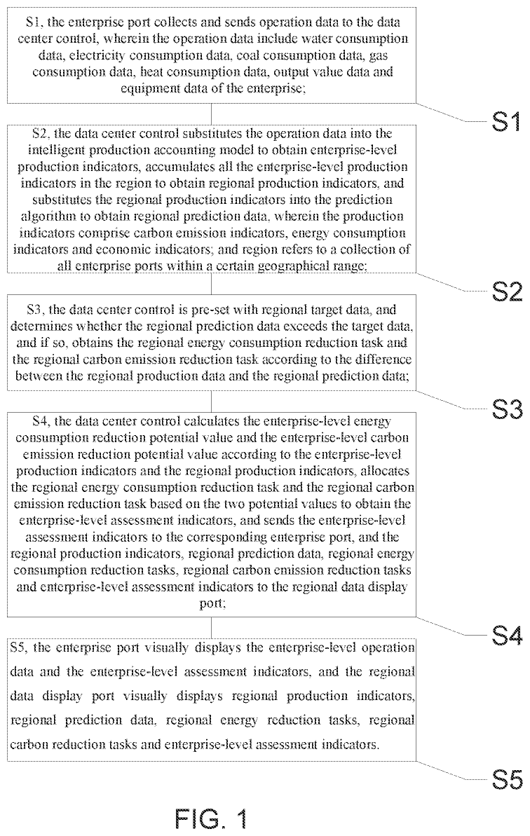

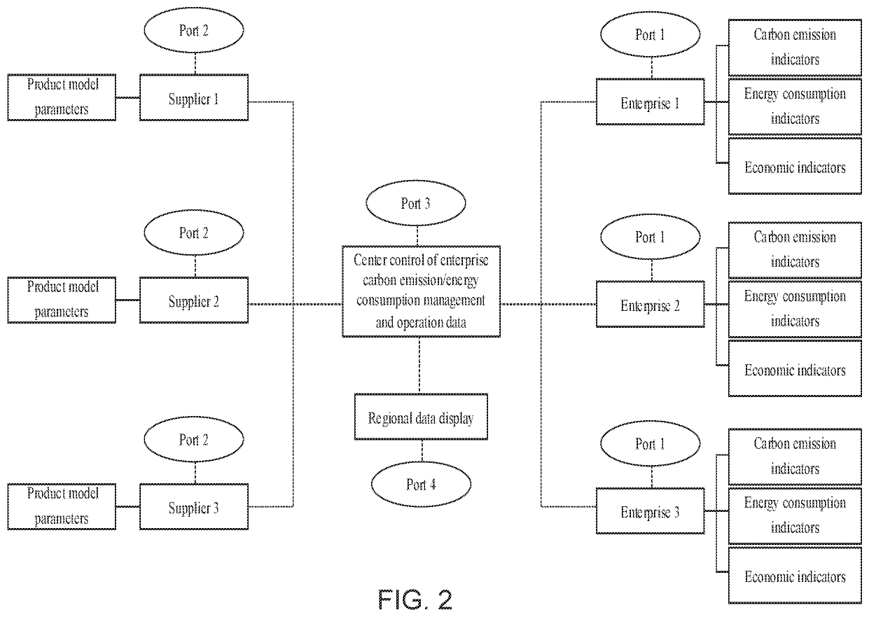

As shown in FIG. 1 and FIG. 2, an enterprise carbon emission/energy consumption data management and operation method based on blockchain, comprises:

S1, the enterprise port collects and sends operation data to the data center control, wherein the operation data include water consumption data, electricity consumption data, coal consumption data, gas consumption data, heat consumption data, output value data and equipment data of the enterprise;

In the above steps, enterprise ports are set in the enterprise, used not only for collecting operation data, but also for the enterprise to retrieve data from the blockchain. Enterprises are generally machinery and equipment manufacturing enterprises, including metal products enterprises, general equipment manufacturing enterprises, special equipment manufacturing enterprises, automobile manufacturing enterprises, railways, ships, aerospace and other transportation equipment manufacturing enterprises, and electrical machinery and equipment manufacturing enterprises. Operation data also include enterprise information, which comprises enterprise name, enterprise address and organization code.

The enterprise port includes the equipment layer, which can be used to collect the operation condition of the enterprise, including the operation in the design, production, processing, assembly and testing of the enterprise products. The equipment layer includes intelligent water meter, intelligent electric meter, intelligent gas meter, intelligent switch, intelligent gateway and temperature and humidity sensor. For example, intelligent water meters collect water consumption data of the enterprise, intelligent gas meters collect gas consumption of the enterprise, and intelligent switches and intelligent gateways collect electricity consumption. The equipment in the equipment data refers to the existing production equipment, and the equipment data comprise the model, quantity, standard technical parameters and supplier contact information of the existing equipment.

S2, the data center control substitutes the operation data into the intelligent production accounting model to obtain enterprise-level production indicators, accumulates all the enterprise-level production indicators in the region to obtain regional production indicators, and substitutes the regional production indicators into the prediction algorithm to obtain regional prediction data, wherein the production indicators comprise carbon emission indicators, energy consumption indicators and economic indicators;

In the above steps, data center control refers to a device for managing and operating data. Region refers to a collection of all enterprise ports within a certain geographical range, which is equivalent to a collection of all enterprises within a certain geographical range. Users may pre-set region in the data center control. Production indicators include carbon emission indicators, energy consumption indicators and economic indicators. Carbon emission indicators include the total carbon emission of the enterprise, energy consumption indicators include the total energy consumption of the enterprise, and economic indicators include the total output value of the enterprise. Regional production indicators represent the sum of production indicators of all enterprises in the specific geographical range. Regional prediction data refers to the carbon emission indicators, energy consumption indicators and economic indicators predicted to reach in the region in a certain time in future.

S3, the data center control is pre-set with regional target data, and determines whether the regional prediction data exceeds the target data, and if so, obtains the regional energy consumption reduction task and the regional carbon emission reduction task according to the difference between the regional production data and the regional prediction data;

In the above steps, regional target data refers to the carbon emission indicators, energy consumption indicators and economic indicators expected to reach in the region in a certain time in future (which may be the following year). Users may pre-set regional target data in the data center control. Specifically, the regional target data can be set according to the peak carbon dioxide emissions policy formulated by the state. For example, if the region is set to Beijing, from 2022 to 2025, Beijing's peak carbon dioxide emissions policy is to reduce the total carbon dioxide emissions of enterprises by 18% and the total energy consumption of enterprises by 13.5%. The task of reducing energy consumption at regional level includes the difference between the energy consumption indicators in regional production data and the energy consumption indicators in regional prediction data. The task of reducing energy consumption at regional level includes the difference between the carbon emission indicators in regional production data and the carbon emission indicators in regional prediction data.

S4, the data center control calculates the enterprise-level energy consumption reduction potential value and the enterprise-level carbon emission reduction potential value according to the enterprise-level production indicators and the regional production indicators, allocates the regional energy consumption reduction task and the regional carbon emission reduction task based on the two potential values to obtain the enterprise-level assessment indicators, and sends the enterprise-level assessment indicators to the corresponding enterprise port, and the regional production indicators, regional prediction data, regional energy consumption reduction tasks, regional carbon emission reduction tasks and enterprise-level assessment indicators to the regional data display port;

In the above steps, the enterprise-level energy reduction potential value is positively correlated with the ratio of enterprise energy consumption indicators to regional energy consumption indicators, and the enterprise-level carbon emission potential value is positively correlated with the ratio of enterprise carbon emission indicators to regional carbon emission indicators. The higher the enterprise-level energy reduction potential value, the larger energy reduction task assigned to the enterprise. The higher the enterprise-level carbon emission reduction potential value, the larger carbon emission reduction task assigned to the enterprise. The enterprise-level assessment indicators are positively correlated to the enterprise-level energy reduction potential value.

S5, the enterprise port visually displays the enterprise-level operation data and the enterprise-level assessment indicators, and the regional data display port visually displays regional production indicators, regional prediction data, regional energy reduction tasks, regional carbon reduction tasks and enterprise-level assessment indicators;

In the above steps, enterprise port further includes an enterprise visual device, which may be a display screen for displaying enterprise-level operation data and enterprise-level assessment indicators. The regional data display port includes a regional data visualization device, which may be a display screen for displaying data such as regional production indicators, regional prediction data, regional energy consumption reduction tasks, regional carbon emission reduction tasks and enterprise assessment indicators.

The enterprise port can also visually display the energy saving and emission reduction report, which contains such information as the configuration capacity of new energy equipment, the configuration scale of energy saving equipment, the energy consumption saved annually per unit input, the carbon reduction value per unit input in new energy, the comparison of energy consumption values before and after input, the comparison of carbon emission values before and after input, the return on investment ratio, the predicted annual rate of return, and the return cycle.

S2 specifically comprises the following steps:

S21, compiling the production calculation formula into a production calculation formula in the form of intelligent contract code, wherein the production calculation formula comprises a carbon emission calculation formula, an energy consumption calculation formula and an economic calculation formula;

In the above steps, the production calculation formula that complies with the coding requirements and the bare metal requirements of the intelligent contract enables the data obtained subsequently to be universal, confidential and unified, and errors caused by inconsistent codes at various blockchain nodes avoided.

S22, compiling the production calculation formula in the form of intelligent contract code into the intelligent contract to obtain an intelligent production accounting model, which contains a signature, a timestamp and a Hash function;

In the above steps, since the operation data of the enterprise are designed with various processes, all kinds of materials and multiple statistical objects, big error is likely to occur in manual accounting. The adoption of the intelligent production accounting model to uniformly account the carbon emissions, energy consumption and economy in the whole operation of the enterprise will improve the efficiency and accuracy of the accounting.

S23: substituting the operation data into the intelligent production accounting model to calculate the enterprise-level production indicators, which will be uploaded to the blockchain network; the blockchain network comprises blockchain nodes, and the blockchain nodes comprise enterprise ports, data center control and regional data display port.

In the above steps, the enterprise-level production indicators are uploaded to the blockchain network, where they can be permanently stored without tampering, thereby improving the authenticity and credibility of the data obtained by the blockchain-based enterprise carbon emission/energy consumption data management and operation method.

The intelligent contract code adopts Turing complete programming language.

In addition, by Step S21-23, enterprise-level operation data, enterprise-level assessment indicators and regional data display ports can also upload regional production indicators, regional prediction data, regional energy consumption reduction tasks, regional carbon emission reduction tasks and enterprise-level assessment indicators to the blockchain network.

In addition, the data center control also builds an intelligent contract, which specifically includes the following steps:
P1: build an intelligent contract core system in the blockchain network, use Turing complete programming language to write the intelligent contract code, substitute the intelligent contract code into the one-way hash function to calculate the contract file address, substitute the account address and contract name of the initiator into the one-way hash function to calculate the contract installation address, and store the corresponding relationship between the contract installation address and the contract file address in the blockchain network;
P2: update the intelligent contract core system in the blockchain network, substitute the updated intelligent contract code into the one-way hash function to calculate the updated contract file address, substitute the updated initiator's account address and contract name into the one-way hash function to calculate the updated contract installation address, and overwrite the corresponding relationship between the contract installation address and the contract file address previously stored in the blockchain network.

The carbon emission calculation formula is

Eₜₒₜₐₗ=Σᵢⁿ(NCVᵢ×FCᵢ×CCᵢ×OFᵢ×44/12)+(ΣETDₘ+E_{WD})+(AD_{electricity}×EF_{electricity})+(ADₕₑₐₜ×0.11)

In which, Eₜₒₜₐₗ refers to the total greenhouse gas emissions of an enterprise, i refers to the types of fossil fuels, NCV refers to the average low calorific value of the type i fossil fuels, FCᵢ refers to the net consumption of the type i fossil fuels, CCᵢ refers to the unit heat value carbon content of the type i fossil fuels, OFᵢ refers to the carbon oxidation rate of the type i fossil fuels, m refers to the types of greenhouse gases, ETD m refers to the leakage of the type i greenhouse gas, AD_{electricity} refers to the net purchased electricity of the enterprise, EF_{electricity} refers to the annual average emission factor of the power grid in the region, and ADₕₑₐₜ refers to the net purchased heat of the enterprise;

S3 specifically comprises the following steps:

S31, the regional data display port visually displays a slidable time progress bar;

Wherein, the whole time progress bar can be visualized as a small square on the visualization device, and only when the regional production indicators, regional prediction data, regional energy consumption reduction task, regional carbon emission reduction task and enterprise assessment indicators are visually displayed on the regional data display port can the time progress bar be visually displayed.

S32: when the time progress bar is slid on the regional data display port, the regional data display port can display regional production indicators and regional prediction data of different time.

Specifically, the regional data visualization device is a touch screen. Touch the time progress bar and slide it on the regional data visualization device. The time progress bar can be slid linearly on the enterprise's visualization device. For example, if the user slides the time progress bar to the left, the regional data display port visually displays the regional production indicators and regional prediction data of earlier time. If the user slides the bar to the right, the regional data display port visually displays the regional production indicators and regional prediction data of later time.

When determining whether the regional prediction data exceeds the regional target data, it specifically comprises the following steps:

The data center control determines whether the regional prediction data at a certain time node exceeds the regional prediction value at the corresponding time node.

In the above steps, a certain time node and the corresponding time node are at the same time. By comparing the regional prediction data and regional prediction value at the same time, the data processing efficiency can be improved. In practical use, determine whether the regional prediction data at “n” time nodes exceed the regional prediction values at the corresponding time nodes, and if so, obtain the regional energy saving task and the regional carbon emission reduction task according to the difference between the regional production data and the regional prediction data, thus improving the accuracy of judgment.

The blockchain-based enterprise carbon emission/energy consumption data management and operation method also comprises:

S6, the data center control determines whether the enterprise production indicators have the corresponding enterprise assessment indicators, if so, whether the former are higher than the latter, and if so, it determines that the enterprise has won the policy reward.

In the above steps, if the data center control judges that the enterprise has won the policy award, it will send the relevant information to the enterprise port for visual display, so as to remind the enterprise to receive the award, and the enterprise may apply to the government for the award through the enterprise port. Otherwise, the center control will judge that the enterprise will not get the policy reward. Policy reward may include cash, tax incentives, honorary titles and other forms.

If the enterprise applies to the government for a policy award, the government may review the data through the enterprise port or the data center control or regional data display port. Once approved, the policy reward will be granted to the enterprise.

The blockchain-based enterprise carbon emission/energy consumption data management and operation method also comprises:

S7, the data center control is set with a new energy equipment database, from which the new energy equipment data are retrieved based on the operation data and production indicators. The new energy equipment database is a collection of new energy equipment data, including the model, quantity and price of new energy equipment;

In the above steps, the new energy equipment includes photovoltaic equipment, fan equipment and energy storage equipment. An objective function is established between the operation data and production indicators with the new energy equipment database, and the data center control substitutes the operation data and production indicators into the objective function to retrieve the corresponding new energy equipment data.

S8, an energy saving and emission reduction report is generated based on the operation data, production indicators and new energy equipment data, and sent to the enterprise ports. In the report, new energy equipment data, input amount, configuration capacity, configuration scale of new energy equipment, annual energy saving value after new energy equipment input, annual carbon reduction value after new energy equipment input, energy consumption ratio before and after new energy equipment input, carbon emission ratio before and after new energy equipment input, return ratio of new energy equipment input, prediction annual return rate after new energy equipment input, and return cycle after new energy equipment input are included;

In the above steps, the input amount for new energy equipment is the total amount required to purchase new energy equipment, calculated by the product of the quantity and price of new energy equipment. The configuration capacity of new energy equipment refers to the equipment's total configuration memory, calculated based on the quantity and model of the new energy equipment. The configuration scale of new energy equipment refers to the overall performance of the equipment, also calculated according to the number and model of the new energy equipment. The annual energy saving value per unit input of new energy equipment refers to the result of the difference between the annual energy consumption value of new energy equipment input and the annual energy consumption indicators of the enterprises divided by the quantity of the new energy equipment. First, calculate the annual energy consumption of new energy equipment input based on their model and quantity, and then divide the difference between the annual energy consumption value of new energy equipment input and the annual energy consumption indicators of the enterprise by the quantity of the new energy equipment. The annual carbon emission reduction value saved per unit input of new energy equipment refers to the result of the difference between the annual carbon emission value of new energy equipment input and the annual carbon emission indicators of the enterprise divided by the quantity of the new energy equipment. First, calculate the annual carbon emission value of new energy equipment input according to the model and quantity of new energy equipment, and then divide the difference between the annual carbon emission value of new energy equipment input and the annual carbon emission indicators of the enterprise by the quantity of the new energy equipment. The energy consumption ratio before and after new energy equipment input refers to the ratio between the annual energy consumption value of new energy equipment input and the annual energy consumption indicators of the enterprise. The carbon emission ratio before and after new energy equipment input refers to the ratio between the carbon emission indicators of the enterprise before the input of new energy equipment and the expected carbon emission indicators after input of the new energy equipment.

S9, the enterprise port visually displays the energy saving and emission reduction report;

In the above steps, the enterprise can browse the energy saving and emission reduction report through the enterprise port, and then decide the necessity of purchasing the corresponding new energy equipment. If so, the enterprise can use the supplier contact information in the new energy equipment data to contact suppliers. Specifically, enterprise ports and supplier ports are interconnected, so that through the enterprise ports, the enterprise gets in touch with suppliers who use supplier ports.

The new energy equipment database is provided to the data control center through the supplier ports, so that suppliers can build and update the new energy database through the supplier ports.

Specifically, if an enterprise purchases new energy equipment, the equipment data collected by the enterprise port will be updated, and so are the equipment data in the data center control.

In addition, the invention also discloses a blockchain-based enterprise carbon emission/energy consumption data management and operation system, which is used for executing the blockchain-based enterprise carbon emission/energy consumption data management and operation method. The blockchain-based enterprise carbon emission/energy consumption data management and operation system comprises enterprise ports, a data center control, a regional data display port and supplier ports, which are connected in communication, and the enterprise ports, data center control and regional data display port are a part of the blockchain network. The enterprise ports are used to collect operation data and visually displayed data, which include operation data, production indicators, enterprise-level operation data and enterprise-level assessment indicators. The data center control is used to process and manage data, including production data. The regional data display port is used to visually display data, including regional production indicators, regional prediction data, regional energy consumption reduction tasks, regional carbon emission reduction tasks and enterprise-level assessment indicators. The supplier ports are to send the new energy equipment database to the data center control, and suppliers can build and update the new energy equipment database through the supplier ports.

The embodiments described above are only the preferred embodiments of the present invention that will not limit the scope of protection of the present invention. Therefore, all equivalent changes made to the structure, shape and principle of the present invention should be covered in the scope of protection of the present invention.

1. A blockchain-based data management and operation method for carbon emission/energy consumption of enterprises, which is characterized in that the method comprises:
S1, the enterprise port collects and sends operation data to the data center control, wherein the operation data include water consumption data, electricity consumption data, coal consumption data, gas consumption data, heat consumption data, output value data and equipment data of the enterprise;
S2, the data center control substitutes the operation data into the intelligent production accounting model to obtain enterprise-level production indicators, accumulates all the enterprise-level production indicators in the region to obtain regional production indicators, and substitutes the regional production indicators into the prediction algorithm to obtain regional prediction data, wherein the production indicators comprise carbon emission indicators, energy consumption indicators and economic indicators;
S3, the data center control is pre-set with regional target data, and determines whether the regional prediction data exceeds the target data, and if so, obtains the regional energy consumption reduction task and the regional carbon emission reduction task according to the difference between the regional production data and the regional prediction data;
S4, the data center control calculates the enterprise-level energy consumption reduction potential value and the enterprise-level carbon emission reduction potential value according to the enterprise-level production indicators and the regional production indicators, allocates the regional energy consumption reduction task and the regional carbon emission reduction task based on the two potential values to obtain the enterprise-level assessment indicators, and sends the enterprise-level assessment indicators to the corresponding enterprise port, and the regional production indicators, regional prediction data, regional energy consumption reduction tasks, regional carbon emission reduction tasks and enterprise-level assessment indicators to the regional data display port;
S5, the enterprise port visually displays the enterprise-level operation data and the enterprise-level assessment indicators, and the regional data display port visually displays regional production indicators, regional prediction data, regional energy reduction tasks, regional carbon reduction tasks and enterprise-level assessment indicators;
S6, the data center control determines whether the enterprise production indicators have the corresponding enterprise assessment indicators, if so, whether the former are higher than the latter, and if so, it determines that the enterprise has won the policy reward;
S7, the data center control is set with a new energy equipment database, from which the new energy equipment data are retrieved based on the operation data and production indicators. The new energy equipment database is a collection of new energy equipment data, including the model, quantity and price of new energy equipment, and the data are submitted to the data center control through supplier ports;
S8, an energy saving and emission reduction report is generated based on the operation data, production indicators and new energy equipment data, and sent to the enterprise ports. In the report, new energy equipment data, input amount, configuration capacity, configuration scale of new energy equipment, annual energy saving value after new energy equipment input, annual carbon reduction value after new energy equipment input, energy consumption ratio before and after new energy equipment input, carbon emission ratio before and after new energy equipment input, return ratio of new energy equipment input, prediction annual return rate after new energy equipment input, and return cycle after new energy equipment input are included;
S9, enterprise port visually displays the energy saving and emission reduction report;
S2 specifically comprises the following sub-steps:
S21, compiling the production calculation formula into a production calculation formula in the form of intelligent contract code, wherein the production calculation formula comprises a carbon emission calculation formula, an energy consumption calculation formula and an economic calculation formula, and the carbon emission calculation formula is:
Eₜₒₜₐₗ=Σᵢⁿ(NCVᵢ×FCᵢ×CCᵢ×OFᵢ×44/12)+(ΣETDₘ+E_{WD})+(AD_{electricity}×EF_{electricity})+(ADₕₑₐₜ×0.11)
In which, Eₜₒₜₐₗ refers to the total greenhouse gas emissions of an enterprise, i refers to the types of fossil fuels, NCVᵢ refers to the average low calorific value of the type i fossil fuels, FCᵢ refers to the net consumption of the type i fossil fuels, CCᵢ refers to the unit heat value carbon content of the type i fossil fuels, OFᵢ refers to the carbon oxidation rate of the type i fossil fuels, m refers to the types of greenhouse gases, ETDₘ refers to the leakage of the type i greenhouse gas, AD_{electricity} refers to the net purchased electricity of the enterprise, EF_{electricity} refers to the annual average emission factor of the power grid in the region, and ADₕₑₐₜ refers to the net purchased heat of the enterprise;
S22, compiling the production calculation formula in the form of intelligent contract code into the intelligent contract to obtain an intelligent production accounting model, which contains a signature, a timestamp and a Hash function;
S23: substituting the operation data into the intelligent production accounting model to calculate the enterprise-level production indicators, which will be uploaded to the blockchain network; the blockchain network comprises blockchain nodes, and the blockchain nodes comprise enterprise ports, data center control and regional data display port.

2. The blockchain-based enterprise carbon emission/energy consumption data management and operation method as set forth in claim 1, which is characterized in that the method is implemented by a blockchain-based enterprise carbon emission/energy consumption data management and operation system, which comprises enterprise ports, a data center control, a regional data display port and supplier ports, connected in communication. The enterprise port is to collect operation data and visually display data, the data center control is to process and manage data, the regional data display port is to visually display data, and the supplier port is to provide new energy equipment database to the data center control.

3. The blockchain-based enterprise carbon emission/energy consumption data management and operation method as set forth in claim 1, which is characterized in that the intelligent contract code adopts a Turing complete programming language.

4. The blockchain-based enterprise carbon emission/energy consumption data management and operation method as set forth in claim 1, which is characterized in that S3 specifically comprises the following sub-steps:
S31, the regional data display port visually displays a slidable time progress bar;
S32, when the time progress bar is slid on the regional data display port, the regional data display port can display regional production indicators and regional prediction data of different time.

5. The blockchain-based enterprise carbon emission/energy consumption data management and operation method as set forth in claim 1, which is characterized in that when determining whether the regional prediction data exceed the regional target data, it specifically comprises the following steps:
The data center control judges whether the regional prediction data at a certain time node exceed the regional prediction value at the corresponding time node.
